(19) United States
(12) Patent Application Publication
(10) Pub. No.: US 2008/0055201 A1
(43) Pub. Date: Mar. 6, 2008

(54) Panel interface device, LSI for image processing, digital camera and digital equipment

(76) Inventor: Jun Kajiwara, Kyoto (JP)

Correspondence Address: MCDERMOTT WILL & EMERY LLP, 600 13TH STREET, NW, WASHINGTON, DC, 20005-3096, US

(21) Appl. No.: 11/896,359

(22) Filed: Aug. 31, 2007

(30) Foreign Application Priority Data
Aug. 31, 2006 (JP) 2006-236158
Jun. 27, 2007 (JP) 2007-169163

(51) Int. Cl. G09G 3/28

(52) U.S. Cl. 345/60

(57) ABSTRACT

The panel interface control device, which eliminates the necessity of newly producing video data for panel display and flexibly responds to a change in the type of display panel, includes a data conversion circuit and an RGB filter circuit that are both programmable and scale up or down a digital video signal for display horizontally and vertically to conform to the screen size of the display panel. An interface section outputs the output of the RGB filter circuit to the display panel as video data.

### CROSS-REFERENCE TO RELATED APPLICATIONS

This application claims priority under 35 U.S.C. §119 on Patent Application No. 2006-236158 filed in Japan on Aug. 31, 2006 and Patent Application No. 2007-169163 filed in Japan on Jun. 27, 2007, the entire contents of which are hereby incorporated by reference.

### BACKGROUND OF THE INVENTION

1. Field of the Invention

The present invention relates to a panel interface control device for generating video data for a display panel such as a liquid crystal panel from a digital video signal for display.

2. Description of Related Art

In conventional panel interface control devices, switching of the operation mode is made between during TV display from during panel display, for example, and the timing of a horizontal sync signal is changed with the switching of the operation mode (see Japanese Patent Gazette No. 2785327, for example).

Conventionally, also, to make the size of a video signal agree with the display size of a display panel during panel display, a line memory is provided for one horizontal period as a unit, to store the video signal in the line memory temporarily and read the stored video signal during the next horizontal period for computation, to thereby perform scaling processing (see Japanese Laid-Open Patent Publication No. 10-161600, for example).

The conventional panel interface control devices have the following problems.

(1) In the case of simultaneous display on a TV screen and a display panel, video data for panel display must be newly prepared.

(2) Since a line memory for storing data for panel display is required, reduction in chip area is not allowed, and this prevents downsizing of the entire system.

(3) The circuit configuration must be changed every time the display panel to be mounted is changed in size, the number of display pixels and the like. Otherwise, control circuits as many as the number of adaptable display panels must be incorporated, and this increases the chip area.

### SUMMARY OF THE INVENTION

An object of the present invention is providing a panel interface control device that eliminates the necessity of newly producing video data for panel display and also can flexibly respond to a change in the type of the display panel.

The first invention is a panel interface control device for generating video data for a display panel based on a received digital video signal for display, the digital video signal being obtained by performing predetermined image processing for an image signal obtained via an optical system, the device including: a digital signal processing section for performing vertical and horizontal scale-up or scale-down processing for the digital video signal for display to conform to a screen size of the display panel; and an interface section for outputting an output of the digital signal processing section to the display panel as the video data at the time of display of an image on the display panel, wherein the digital signal processing section is programmable.

In the panel interface control device of the first invention, the digital video signal for display is preferably a digital video signal for TV output.

In the panel interface control device of the first invention, the device is preferably configured to be able to output video data conforming to screen sizes of a plurality of display panels different in screen size.

In the panel interface control device of the first invention, preferably, the digital signal processing section includes a filter circuit for performing filtering processing involving execution of addition/multiplication and division between adjacent pixels as horizontal scale-up or scale-down processing, and the filter circuit is configured so that a coefficient of multiplication can be set with a register.

In the panel interface control device of the first invention, preferably, the device further includes a thinning section for thinning a horizontal sync signal to be outputted to the display panel. The thinning section is preferably configured so that the position at which the horizontal sync signal is thinned can be set for each field with a register.

In the panel interface control device of the first invention, the display panel may be any of a plurality of types of panels different in video display scheme, but is preferably either one of a liquid crystal panel, an organic EL panel and a plasma panel.

The second invention is an LSI for image processing, including: the panel interface control device of the first invention; and a signal processing part for performing the predetermined image processing to generate the digital video signal for display and supplying the digital video signal for display to the panel interface control device.

The third invention is a digital camera or digital equipment, such as a screen-equipped mobile phone, including the panel interface control device of the first invention.

According to the present invention, an inputted digital video signal for display can be scaled up or down horizontally and vertically to conform to the screen size of the display panel, to thereby output video data conforming to the screen size of the display panel. This eliminates the necessity of producing new video data for panel display in TV/display panel simultaneous display. Also, with no need for providing a line memory for panel display, the device area can be reduced, and thus the present invention is contributable to downsizing of the entire system.

With the digital signal processing section for performing scale-up or scale-down processing being programmable, it is unnecessary to prepare a panel interface control device for each display panel. Also, it is unnecessary to impose a limitation on mountable display panels.

As used herein, the wording “programmable” means that the number of horizontal pixels and the number of vertical lines can be set arbitrarily to conform to the screen size of the display panel on which images are displayed, to thereby perform digital signal processing such as scaling up or down, filtering and thinning and thus permit output of data for display conforming to the screen size. In other words, the size of image data for display can be changed arbitrarily according to a program.

### BRIEF DESCRIPTION OF THE DRAWINGS

FIG. 1 is a block diagram of an imaging apparatus including a panel interface control device of an embodiment of the present invention.

FIG. 2 is a block diagram of a display processing part as a panel interface control device of an embodiment of the present invention.

FIG. 3 shows an exemplary configuration of a filter circuit placed in an RGB filter circuit in FIG. 2.

FIG. 4 is a block diagram of the RGB filter circuit including the filter circuit of FIG. 3.

FIG. 5 is a block diagram of an RGB sequence/pixel position selection circuit in FIG. 4.

FIG. 6 is a conceptual view of an example of filtering in the RGB filter circuit.

FIG. 7 is a timing chart of the filtering of FIG. 6.

FIG. 8 is a conceptual view of another example of filtering in the RGB filter circuit.

FIG. 9 is a timing chart of yet another example of filtering in the RBG filter circuit.

FIG. 10 is a timing chart of yet another example of filtering in the RBG filter circuit.

FIGS. 11A to 11C are timing charts showing an example of processing of a thinning section in FIG. 2.

FIG. 12 shows an exemplary configuration of the thinning section for implementing the processing of FIGS. 11A to 11C.

FIGS. 13A and 13B are views illustrating a circuit for executing line filtering for vertical scale-up or scale-down processing.

FIG. 14 is a block diagram of an imaging apparatus including a panel interface device of another embodiment of the present invention, in which a plurality of display panels are provided.

### DESCRIPTION OF THE PREFERRED EMBODIMENTS

Hereinafter, preferred embodiments of the present invention will be described with reference to the accompanying drawings.

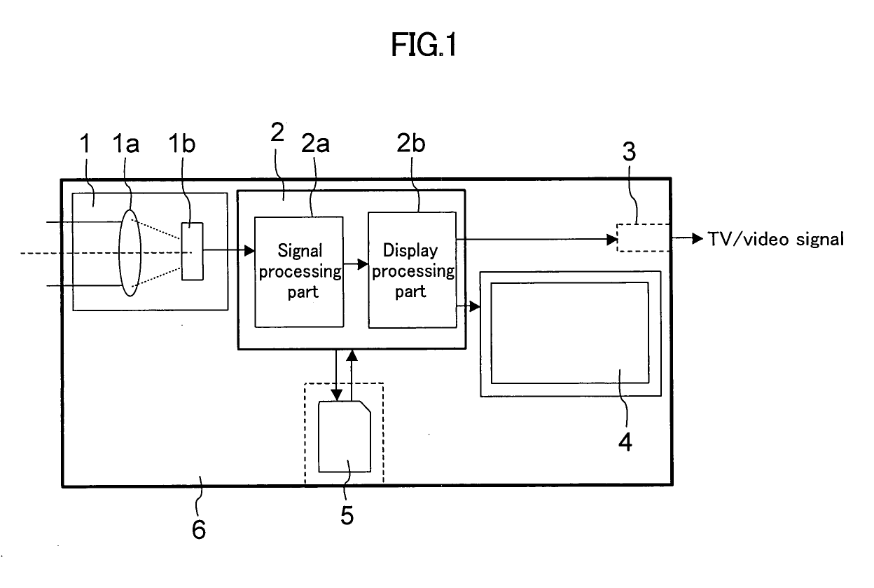

FIG. 1 is a block diagram of a digital camera 6 as an imaging apparatus including a panel interface control device of an embodiment of the present invention. The digital camera 6 in this embodiment uses a liquid crystal panel as the display panel. Referring to FIG. 1, the digital camera 6 includes an optical system 1, an LSI 2 for image processing, a TV output jack 3, a liquid crystal (LC) panel 4 as the display panel and a recording medium 5 such as a memory card. The optical system 1 includes a lens 1a and an imaging device 1b. The image processing LSI 2 includes a signal processing part 2a and a display processing part 2b that corresponds to the panel interface control device.

An image signal obtained via the optical system 1 is inputted into the image processing LSI 2. In the image processing LSI 2, the signal processing part 2a subjects the inputted image signal to digital signal processing as predetermined image processing, to generate a digital video signal for display. The display processing part 2b generates a composite signal for TV display from the digital video signal for display generated in the signal processing part 2a, and outputs the composite signal to the TV output jack 3. That is to say, the inputted digital video signal for display is a digital video signal for TV output. The display processing part 2b also generates video data for the LC panel 4 from the digital video signal for display generated in the signal processing part 2a, and outputs the resultant video data to the LC panel 4. In addition, the image processing LSI 2 accesses the recording medium 5 to read/write electronic data for recording or playback of imaged data.

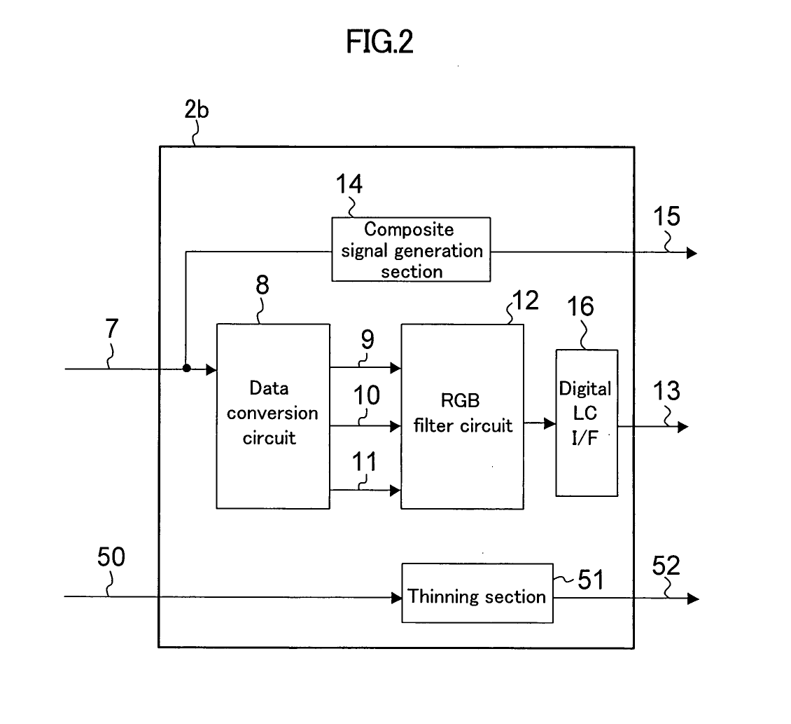

FIG. 2 shows in detail the display processing part 2b as the panel interface control device of this embodiment. Referring to FIG. 2, a data conversion circuit 8 generates an R signal 9, a G signal 10 and a B signal 11 from an inputted digital video signal 7 for display (luminance signal and color difference signals) and outputs the resultant signals. An RGB filter circuit 12 filters the R, G and B signals 9, 10 and 11 to conform to the screen size of the LC panel 4. A digital liquid crystal (LC) interface section 16 supplies the output of the RGB filter circuit 12 to the LC panel 4 as video data 13 during display of still images or moving images on the LC panel 4. The data conversion circuit 8 and the RGB filter circuit 12 constitute a digital signal processing section, and the digital LC interface section 16 constitutes an interface section.

The digital signal processing section composed of the data conversion circuit 8 and the RGB filter circuit 12 is programmable. The wording “programmable” as used herein means that the number of horizontal pixels and the number of vertical lines can be set arbitrarily to conform to the screen size of the LC panel on which images are displayed, to thereby perform digital signal processing such as scaling up or down, filtering and thinning and thus permit output of display data conforming to the screen size.

In FIG. 2, also, a composite signal generation section 14 generates a composite signal 15 from the inputted digital video signal 7 for display and outputs the resultant signal. A thinning section 51 thins an inputted horizontal sync signal 50 to conform to the screen size of the LC panel 4, and outputs a thinned horizontal sync signal 52 to the LC panel 4.

In this embodiment, assume that filtering processing involving addition/multiplication and division between adjacent pixels is performed for horizontal scale-up or scale-down processing to the screen size of the LC panel 4.

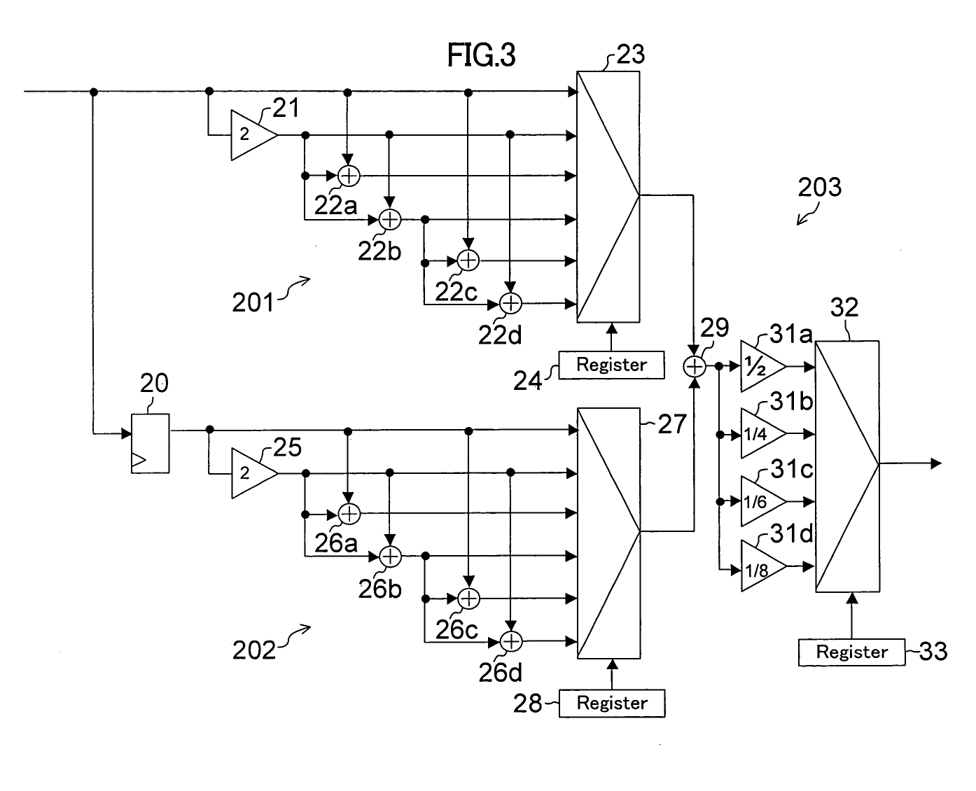

FIG. 3 shows an exemplary configuration of a filter circuit in the RGB filter circuit 12. In FIG. 3, a first multiplication portion 201 includes a multiplier 21, adders 22a, 22b, 22c and 22d, a selector 23 and a register 24. The selector 23 selects one signal from six different signals (gain: 1, 2, 3, 4, 5 and 6) obtained with the multiplier 21 and the adders 22a to 22d according to a set value of the register 24. In other words, the first multiplication portion 201 multiplies the inputted signal by a gain set in the register 24.

Likewise, a second multiplication portion 202 includes a multiplier 25, adders 26a, 26b, 26c and 26d, a selector 27 and a register 28. A flipflop 20 is provided upstream from the second multiplication portion 202, so that a signal delayed by one clock with the flipflop 20 is given to the second multiplication portion 202. The selector 27 selects one signal from six different signals (gain: 1, 2, 3, 4, 5 and 6) obtained with the multiplier 25 and the adders 26a to 26d according to a set value of the register 28. In other words, the second multiplication portion 202 multiplies a signal one-clock delayed from the inputted signal by a gain set in the register 28.

As described above, the first and second multiplication portions 201 and 202 are respectively configured so that the coefficient of multiplication can be arbitrarily set with the registers 24 and 28. An adder 29 sums the output of the selector 23 of the first multiplication portion 201 and the output of the selector 27 of the second multiplication portion 202.

A division portion 203 includes dividers (bit shifters) 31a, 31b, 31c and 31d, a selector 32 and a register 33. The selector 32 selects one signal from four different signals (gain: ½, ¼, ⅙ and ⅛) obtained with the dividers 31a to 31d according to a set value of the register 33.

In FIG. 3, exemplified was a configuration for filtering between two adjacent pixels using one-clock delay. Likewise, filtering among three adjacent pixels, for example, can also be implemented with a similar configuration. Although six different multipliers were used in each multiplication portion and four different divisors were used in the division portion, these numbers can be determined arbitrarily.

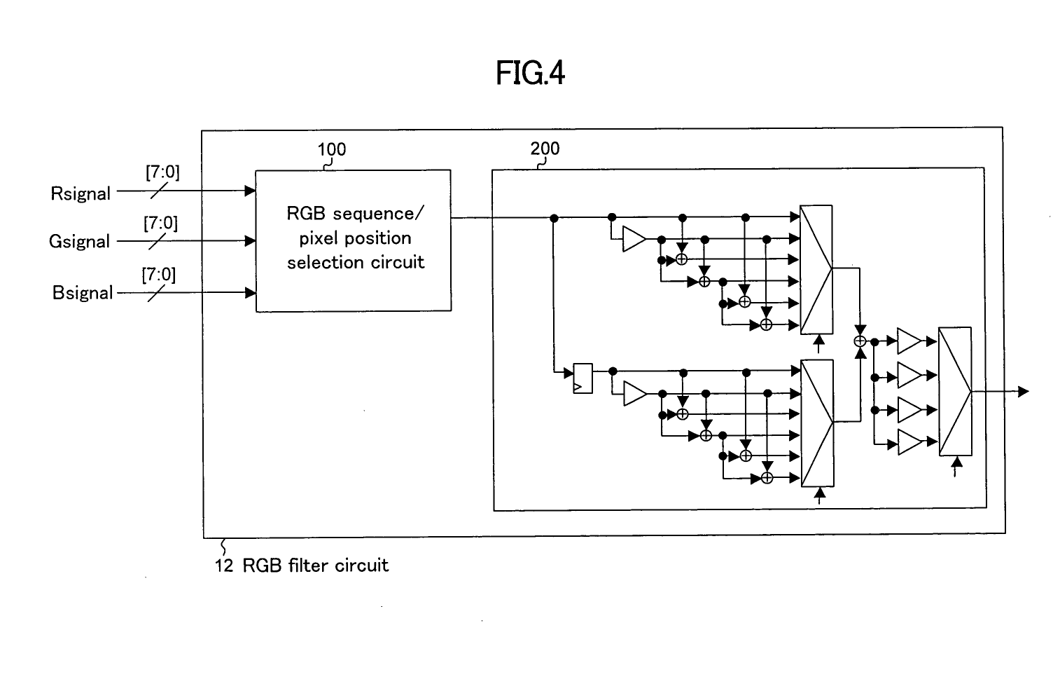

FIG. 4 shows an exemplary configuration of the RGB filter circuit 12 including the filter circuit of FIG. 3. As is found from FIG. 4, the filter circuit of FIG. 3, denoted by 200, is shared among R, G and B in this embodiment. Specifically, an RBG sequence/pixel position selection circuit 100 to be detailed later is placed upstream from the filter circuit 200, to output any one of the R, G and B signals at a time.

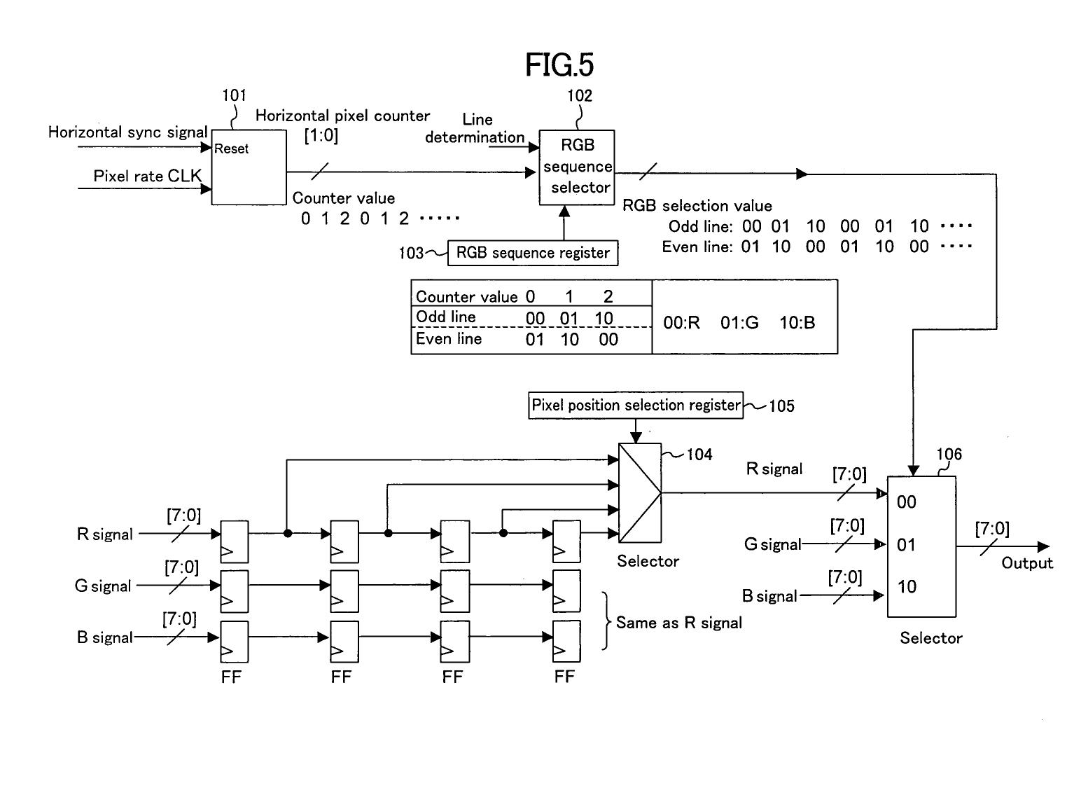

FIG. 5 shows an exemplary configuration of the RBG sequence/pixel position selection circuit 100. As shown in FIG. 5, a selector 104 and a pixel position selection register 105 are provided for an R signal series. The selector 104 receives four R signals different in the number of delay clocks and outputs any one of the R signals according to a value set in the pixel position selection register 105. That is, the set value in the pixel position selection register 105 serves as a control signal for the selector 104 selecting the delay position of the R signal. Although not shown in FIG. 5, a selector and a pixel position selection register are also provided for a G signal series and a B signal series, as in the case of the R signal series. The outputs of the selector 104 and the selectors for the G and B signals are supplied to a selector 106.

A horizontal pixel counter 101 counts a pixel rate CLK and outputs a 2-bit counter value. The counter value is reset with the horizontal sync signal, so as to repeat “0”, “1” and “2” sequentially. An RGB sequence selector 102 determines whether the current line is odd or even and outputs an RGB selection value according to the counter value. The relationship between the line/counter value and the RGB selection value is set in an RGB sequence register 103. An example of setting of the RGB sequence register 103 is shown in FIG. 5, in which “00”, “01” and “10” respectively indicate selection of the R signal, the G signal and the B signal.

The RGB selection value outputted from the RGB sequence selector 102 is supplied to the selector 106 as a selection signal. The selector 106 selects and outputs the R signal if the selection signal is “00”. Likewise, the selector 106 selects and outputs the G signal and the B signal if the selection signal is “01” and “10”, respectively. With this configuration, the sequence of RGB can be switched every output line.

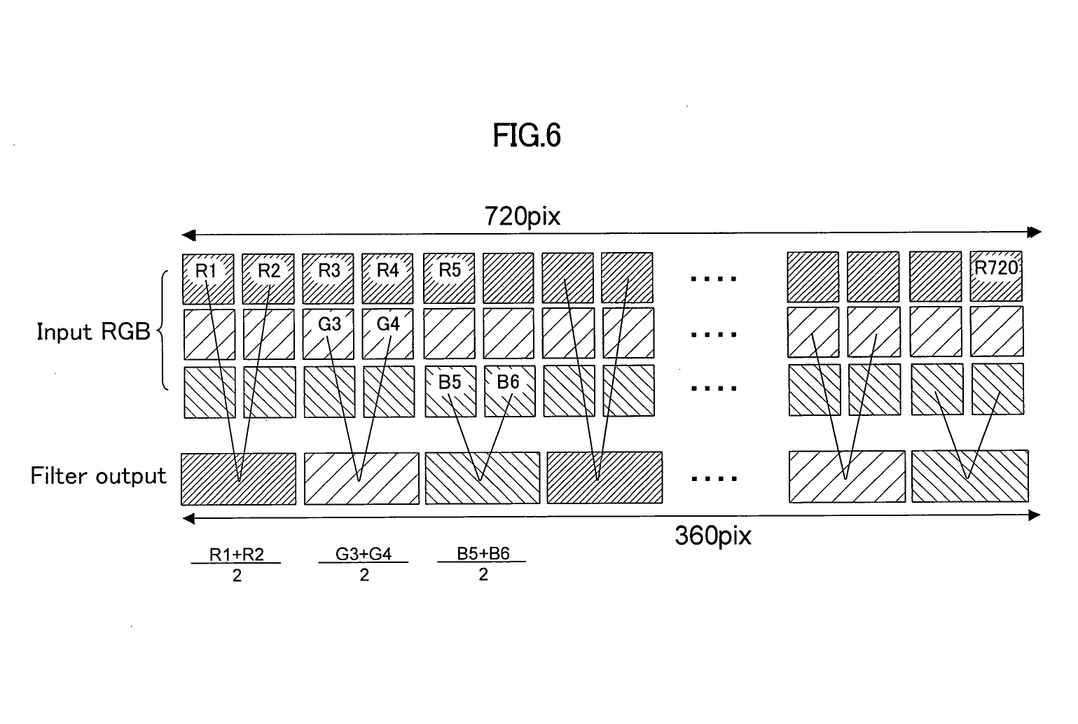

FIG. 6 is a conceptual view of an example of filtering in the RGB filter circuit 12. In this example of filtering, output data of 360 pixels in the horizontal direction is generated from input data of 720 pixels in the horizontal direction. For each of R, G and B, averages of adjacent pixels are outputted.

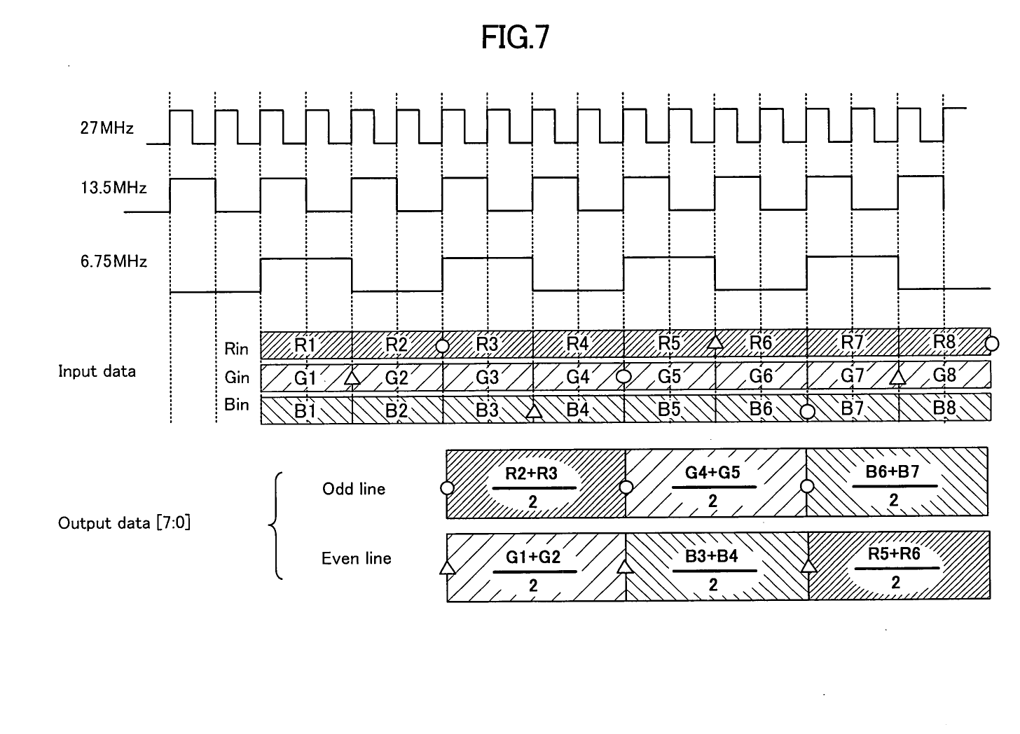

Actually, as shown in the timing chart of FIG. 7, the sequence of RGB and the selected pixel position are switched every output line. Such an operation can be arbitrarily selected with the register setting in the circuit configuration described above. In FIG. 7, the 13.5 MHz waveform represents the data rate of the input data, while the 6.75 MHz waveform represents the data rate of the output data. The 6.75 MHz clock is the pixel rate clock for the LC panel, which corresponds to the pixel rate CLK in FIG. 5 with which the horizontal pixel counter 101 makes counting. The 13.5 MHz clock corresponds to the pixel rate clock adopted until the output of the R, G and B signals in the data conversion circuit 8 in FIG. 2 although not shown. The 27 MHz waveform represents the pixel rate of a signal for TV output.

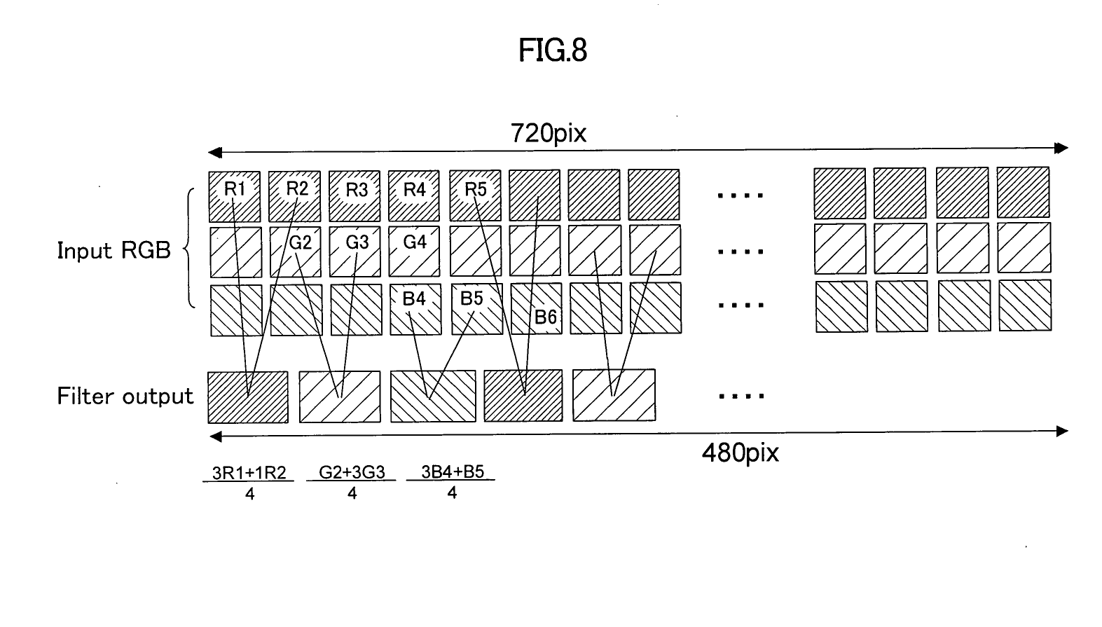

FIG. 8 is a conceptual view of another example of filtering in the RGB filter circuit 12. In this example of filtering, output data of 480 pixels in the horizontal direction is generated from input data of 720 pixels in the horizontal direction. In this case, the simple averaging between adjacent pixels is no more adopted, but the gains of selected pixels must be kept variable considering the pixel center in the filtering. In the example of FIG. 8, the addition gains of adjacent pixels alternate between 3 to 1 and 1 to 3.

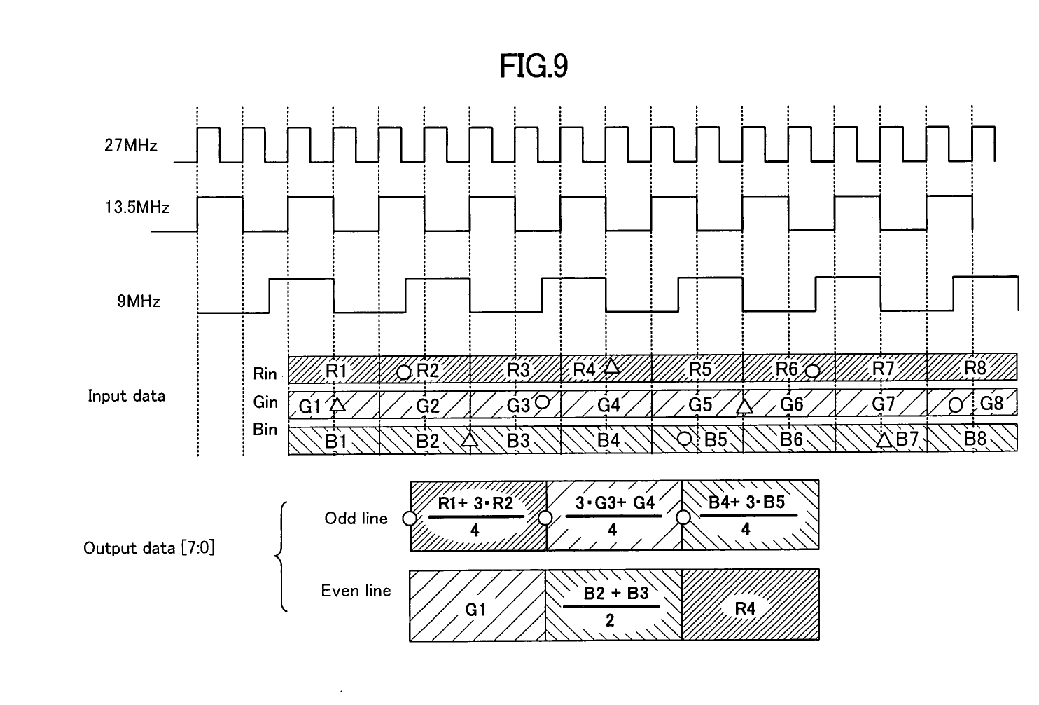

In yet another example of filtering, as shown in FIG. 9, the RGB sequence may differ between odd lines and even lines, and the filter coefficients may change every output line. FIG. 9 shows an example of

for odd lines, alternating between 1 to 3 and 3 to 1 with the divisor value of 4, and

for even lines, alternating between no filtering and 1 to 1.

### In this case, since all of the coefficients of M to N and the devisor value can be set arbitrarily with the registers as described above, any filter coefficient can be supported programmably.

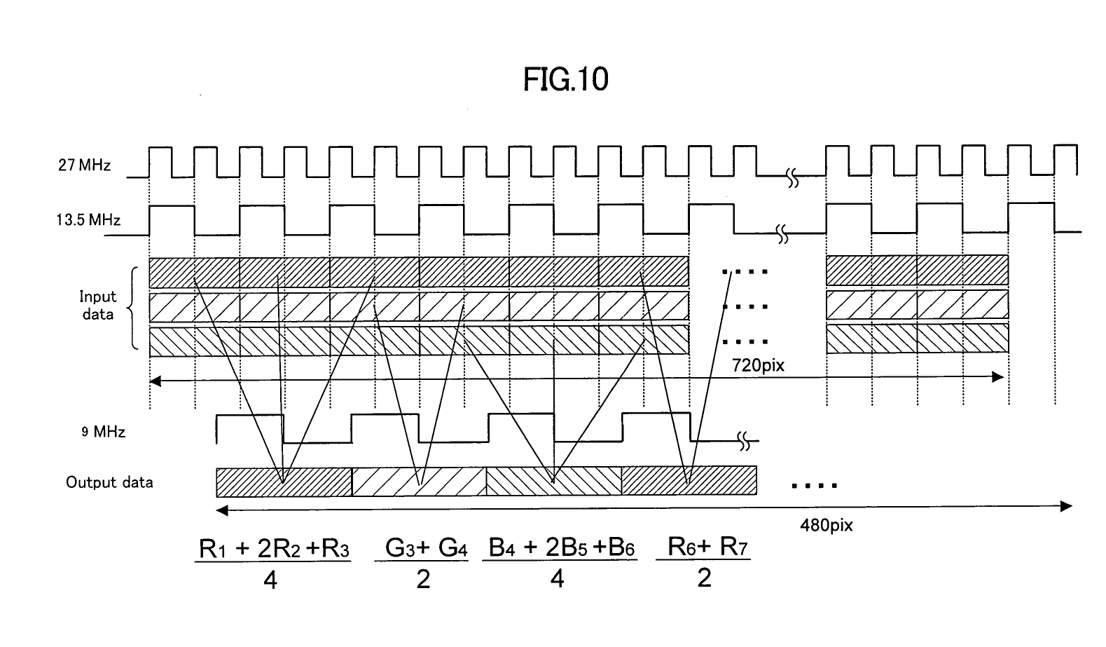

FIG. 10 shows a pattern of

alternating between 1 to 2 to 1 with the divisor value of 4 and 1 to 1 with the divisor value of 2 for even lines.

In this case, also, the pattern can be implemented only with the register setting as described above. In other words, in this embodiment, every pixel pattern can be supported without the necessity of adding a new circuit. In FIGS. 9 and 10, the 13.5 MHz waveform represents the data rate of input data, while the 9 MHz waveform represents the data rate of output data. The 9 MHz clock is the pixel rate clock for the LC panel, which corresponds to the pixel rate CLK in FIG. 5 with which the horizontal pixel counter 101 makes counting. The 13.5 MHz clock corresponds to the pixel rate clock adopted until the output of R, G and B signals in the data conversion circuit 8 in FIG. 2 although not shown. The 27 MHz waveform represents the pixel rate of a signal for TV output.

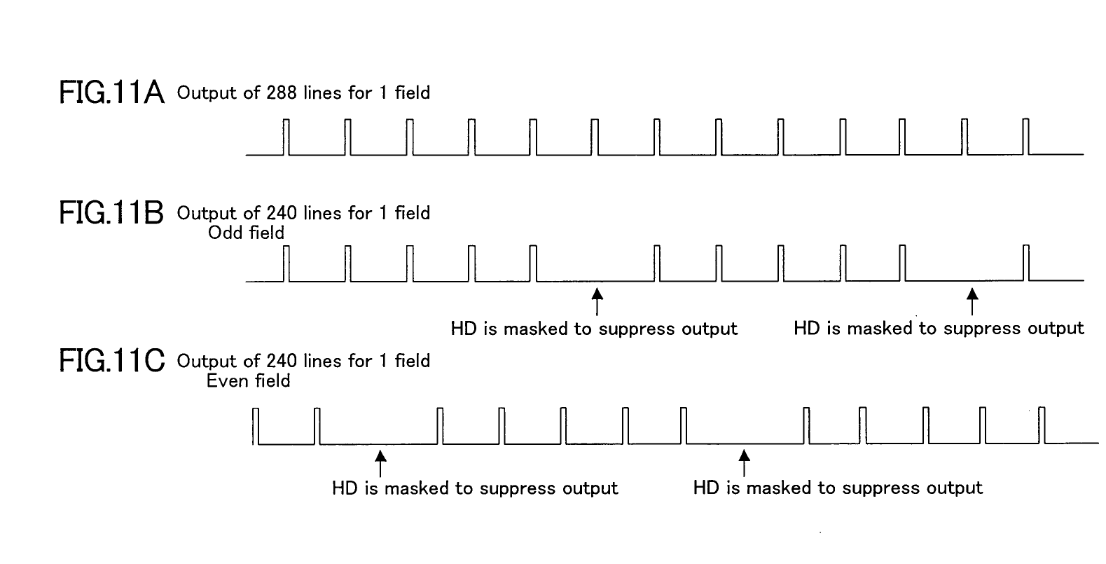

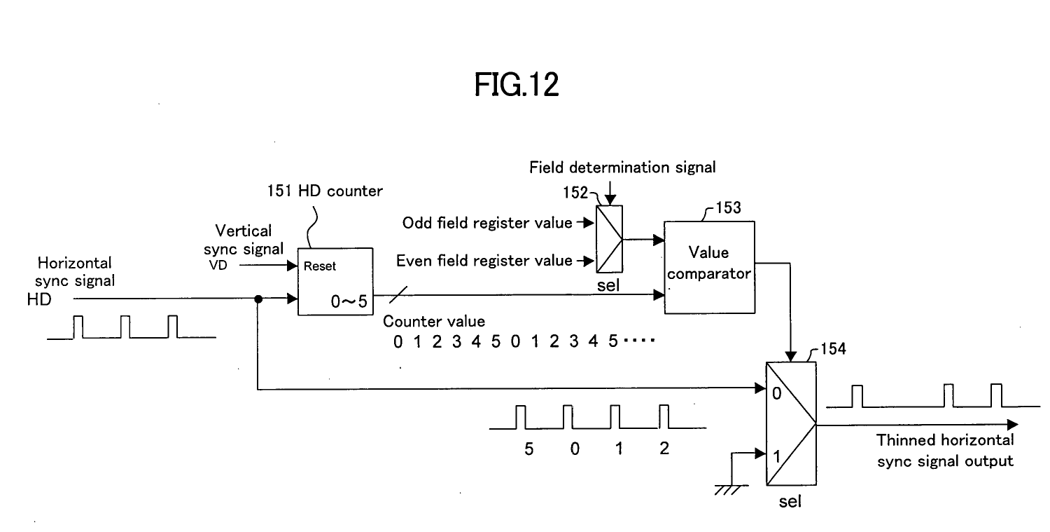

FIGS. 11A to 11C are timing charts showing an example of processing of the thinning section 51, and FIG. 12 shows an exemplary configuration of the thinning section 51 for implementing the processing of FIGS. 11A to 11C. The thinning section 51 thins the horizontal sync signal to be outputted to the LC panel 4 at the time of vertical scale-up or scale-down processing.

Assume herein that the horizontal lines are reduced from 288 lines to 240 lines for each field. FIG. 11A shows a horizontal sync signal observed before scale-down processing, FIG. 11B shows a horizontal sync signal observed in odd fields after the scale-down processing, and FIG. 11C shows a horizontal sync signal observed in even fields after the scale-down processing. As shown in FIGS. 11A to 11C, in the scale-down of horizontal lines from 288 lines to 240 lines, the horizontal sync signal is masked by one line every six lines, and the vertical position of thinning is shifted between odd fields and even fields, to prevent occurrence of flickering.

In FIG. 12, an HD counter 151 counts the horizontal sync signal HD and outputs one of 0 to 5 as the count value. A selector 152 receives a register value for odd fields and a register value for even fields, and selects and outputs either one of the register values according to a field determination signal. A value comparator 153 compares the count value from the HD counter 151 with the output of the selector 152, and outputs “1” if the two values agrees with each other or otherwise outputs “0”. A selector 154 fixes its output to “L” if the value comparator 153 outputs “1”, or outputs the inputted horizontal sync signal HD as it is if the value comparator 153 outputs “0”. As a result, a thinned horizontal sync signal is outputted from the selector 154. That is, the position of thinning in the horizontal sync signal can be set with the register for each field, and the thinning position can be shifted between odd fields and even fields.

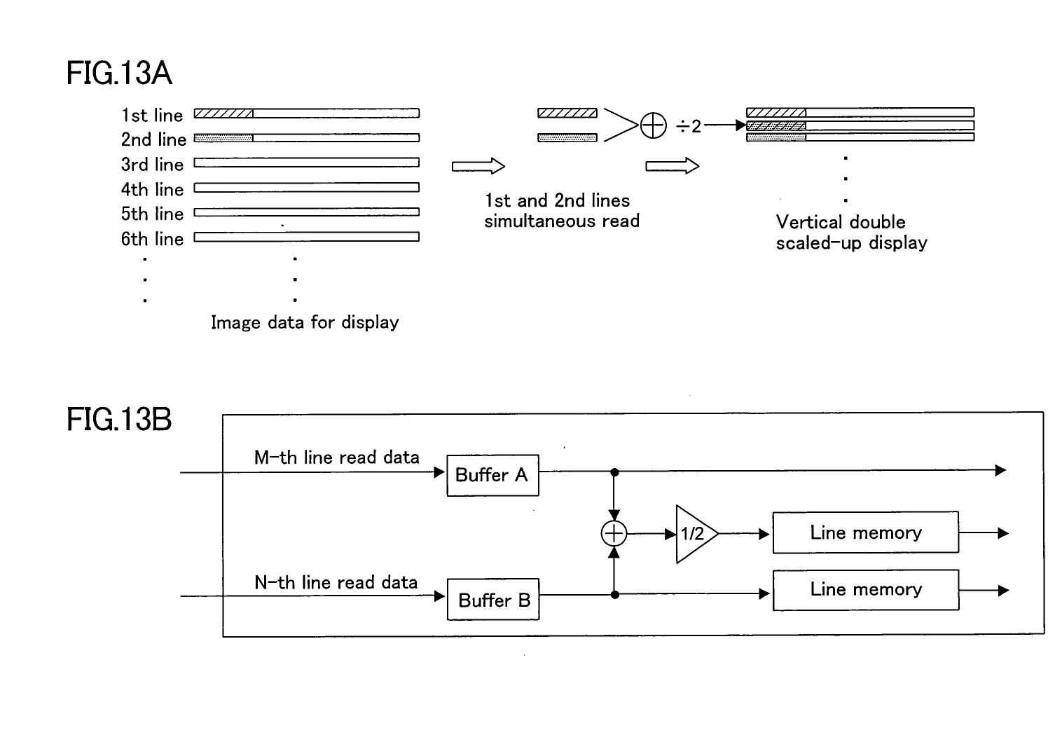

In the display processing part 2b, the data conversion circuit 8 may be provided with a circuit for performing line filtering for vertical scale-up or scale-down processing. As shown in FIG. 13A, assume that image data for display has been expanded in a DRAM external to the image processing LSI 2, for example. Data in the n-th line and data in the (n+1)th line are read simultaneously and averaged to generate new line data. This new line data is interpolated between the n-th line and the (n+1)th line. In this way, data can be doubly scaled up vertically. FIG. 13B shows an exemplary circuit configuration for implementing such scale-up processing. For scale-down processing, a circuit may be configured to thin lines appropriately.

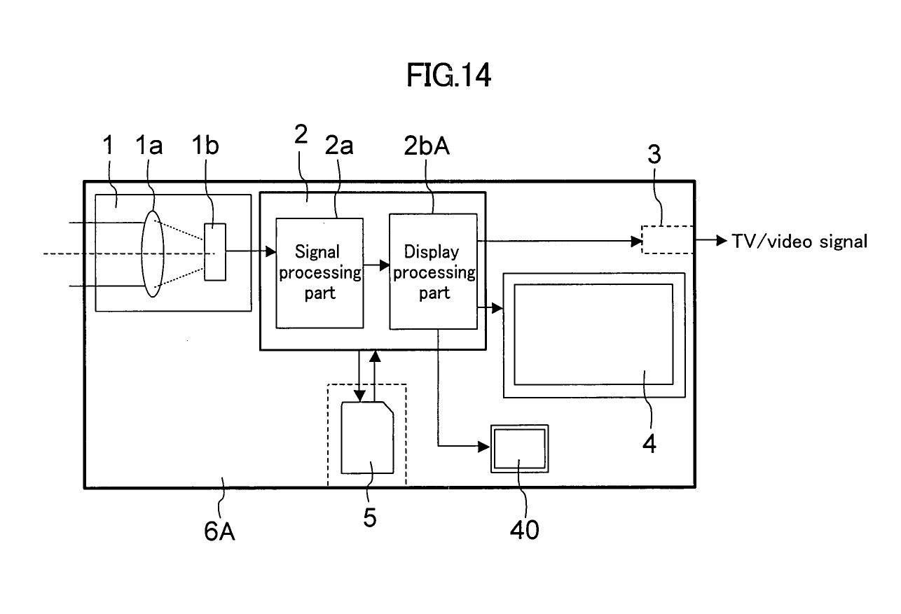

FIG. 14 shows a configuration of a digital camera 6A as an imaging apparatus including a panel interface control device of another embodiment of the present invention. In FIG. 14, components common with those in FIG. 1 are denoted by the same reference numerals, and the description thereof is omitted here. The configuration of FIG. 14 includes a plurality of LC panels as display panels different in screen size. Specifically, in addition to the LC panel 4, an electric view finder 40 for viewing via an eyepiece window is provided as another LC panel. A display processing part 2bA as the panel interface control device is configured to be able to output video data conforming respectively to the screen sizes of the LC panels 4 and 40. That is, for display on the LC panel 4, the filter coefficients in the RGB filter circuit and the thinning are set so as to generate an output image conforming to the screen size of the LC panel 4. For display on the LC panel 40, the filter coefficients in the RGB filter circuit and the thinning are set so as to generate an output image conforming to the screen size of the LC panel 40. In this way, output images conforming to a plurality of LC panels different in screen size can be displayed by the display processing part having one RGB filter circuit.

It is needless to mention that the present invention is not limited to the embodiments described above. For example, although a liquid crystal panel was used as the display panel to describe the configuration and operation of the present invention in the above embodiments, the panel interface control device of the present invention can be implemented also in the case of using a display panel different in video display scheme from the liquid crystal panel, by placing an interface section adapted to this display panel. That is, the present invention is applicable to display panels such as organic EL displays, plasma displays, rear-projection TV sets, FEDs and CRTs.

In the above embodiments, the panel interface control device of the present invention was mounted in a digital camera. Naturally, the panel interface control device of the present invention can also be mounted in other types of digital equipment such as screen-equipped mobile phones.

The panel interface control device of the present invention, which generates video data for display panel from a digital video signal for display, can be usefully mounted in a digital signal processing LSI of a digital camera and the like, for example, and is applicable to, not only digital cameras, but also video signal processing apparatuses that receive a video signal and displays video data on a TV screen and a display panel, for example.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A panel interface control device for generating video data for a display panel based on a received digital video signal for display, the digital video signal being obtained by performing predetermined image processing for an image signal obtained via an optical system, the device comprising:
a digital signal processing section for performing vertical and horizontal scale-up or scale-down processing for the digital video signal for display to conform to a screen size of the display panel; and
an interface section for outputting an output of the digital signal processing section to the display panel as the video data at the time of display of an image on the display panel,
wherein the digital signal processing section is programmable.

2. The device of claim 1, wherein the digital video signal for display is a digital video signal for TV output.

3. The device of claim 1, wherein the device is configured to be able to output video data conforming to screen sizes of a plurality of display panels different in screen size.

4. The device of claim 1, wherein the digital signal processing section comprises a filter circuit for performing filtering processing involving execution of addition/multiplication and division between adjacent pixels as horizontal scale-up or scale-down processing, and
the filter circuit is configured so that a coefficient of multiplication can be set with a register.

5. The device of claim 1, further comprising a thinning section for thinning a horizontal sync signal to be outputted to the display panel.

6. The device of claim 5, wherein the thinning section is configured so that a position at which the horizontal sync signal is thinned can be set for each field with a register.

7. The device of claim 1, wherein the display panel is any of a liquid crystal panel, an organic EL panel and a plasma panel.

8. An LSI for image processing, comprising:
the panel interface control device of claim 1; and
a signal processing part for performing the predetermined image processing to generate the digital video signal for display and supplying the digital video signal for display to the panel interface control device.

9. A digital camera comprising the panel interface control device of claim 1.

10. Digital equipment comprising the panel interface control device of claim 1.
